(19) United States
(12) Patent Application Publication
(10) Pub. No.: US 2022/0147666 A1
(43) Pub. Date: May 12, 2022

(54) METHOD FOR DETERMINING PROPAGATION CHARACTERISTICS OF GUIDED WAVES OF VARIABLE CROSS-SECTION RAIL OF TURNOUT

(71) Applicant: Southwest Jiaotong University, Chengdu (CN)

(72) Inventors: Ping WANG, Chengdu (CN); Jingmang XU, Chengdu (CN); Chenyang HU, Chengdu (CN); Rong CHEN, Chengdu (CN); Le LIU, Chengdu (CN); Boyang AN, Chengdu (CN); Zheng GONG, Chengdu (CN); Jiasheng FANG, Chengdu (CN)

(21) Appl. No.: 17/387,865

(22) Filed: Jul. 28, 2021

(30) Foreign Application Priority Data
Nov. 7, 2020 (CN) 202011234639.8

(51) Int. Cl. G06F 30/23; G06F 17/14

(52) U.S. Cl. CPC G06F 30/23; G06F 2111/10; G06F 17/142

(57) ABSTRACT

The present disclosure relates to the technical field of rail turnouts, and to a method for determining propagation characteristics of guided waves of a variable cross-section rail of a turnout. The method includes the following steps: step 1: establishing dispersion curves: separately calculating dispersion curves of sections of a variable cross-section rail, and fitting dispersion curves of different sections in a similar wave mode according to a longitudinal position to generate a “wavenumber-frequency-position” three-dimensional dispersion surface; step 2: analyzing dispersion characteristics: based on the “wavenumber-frequency-position” three-dimensional dispersion surface, using a semi-analytical finite element method to calculate a wavenumber-frequency dispersion curve and a guided wave structure of the characteristic section; and step 3: performing finite element simulation verification: establishing a switch rail model for simulation, then using two-dimensional fast Fourier transform (2D-FFT) to identify a frequency wavenumber dispersion curve of collected data.

### CROSS-REFERENCE TO RELATED APPLICATION

This application claims priority from the Chinese patent application 202011234639.8 filed Nov. 7, 2020, the content of which is incorporated herein in the entirety by reference

### TECHNICAL FIELD

The present disclosure relates to the technical field of rail turnouts, and in particular, to a method for determining propagation characteristics of guided waves of a variable cross-section rail of a turnout.

### BACKGROUND

Guided waves refer to elastic waves with multi-mode and dispersion characteristics formed due to the existence of structural boundaries. The guided waves are essentially stress waves propagating in a solid structure. In elastic solid kymatology, a solid medium with a certain shape and boundary that can guide a propagation direction of stress waves is usually called waveguide. The study of the mechanism of guided waves propagating in structures is the basis of guided wave theory, which is essential for the mature application of a guided wave-based structural health monitoring technology, and is the cornerstone of subsequent research work. Guided wave-based structural health monitoring is a promising technology that can be used to continuously monitor and identify structural damage. However, because a straight switch rail of a turnout features a variable cross-section along the longitudinal direction of a line, it is still difficult to study the propagation characteristics of guided waves of this structure.

Dispersion curves can not only be used to describe the propagation characteristics and guided wave speed of guided waves in a waveguide medium at different frequencies, but also be used to guide guided wave non-destructive testing experiments, such as selection of guided wave modes, selection of excitation frequencies, and modal identification. Due to the complex geometry of the rail cross-section, it is impossible to obtain a dispersion equation like an elastic body with a regular cross-section. To obtain a dispersion curve of guided waves in a rail, only a numerical method can be used to convert a wave equation to a frequency-domain equation, and then by introducing proper displacement and stress boundary conditions, eigenvalues of the frequency domain equation are solved, so as to obtain a dispersion curve.

The propagation of elastic waves in waveguides with slowly changing cross-sections is a difficult point in existing research, because the dispersion characteristics of wave modes not only change with frequency, but also change with cross-section changes. This means that the wavenumber, phase velocity, and group velocity change continuously for each wave mode. At present, there is no effective numerical method to obtain a dispersion relationship of the variable cross-section straight switch rail, which cannot guide the damage detection of the switch rail.

### SUMMARY

The present disclosure provides a method for determining propagation characteristics of guided waves of a variable cross-section rail of a turnout, which can overcome a certain defect or some defects of the prior art.

The method for determining propagation characteristics of guided waves of a variable cross-section rail of a turnout according to the present disclosure includes the following steps:

step 1: establishing dispersion curves: separately calculating dispersion curves of sections of a variable cross-section rail, and then fitting dispersion curves of different sections in a similar wave mode according to a longitudinal position to generate a “wavenumber-frequency-position” three-dimensional dispersion surface;

step 2: analyzing dispersion characteristics: based on the “wavenumber-frequency-position” three-dimensional dispersion surface, using a semi-analytical finite element method to calculate a wavenumber-frequency dispersion curve and a guided wave structure of the characteristic section; and

step 3: performing finite element simulation verification: using ANSYS to establish a switch rail model for simulation, then using two-dimensional fast Fourier transform (2D-FFT) to identify a frequency wavenumber dispersion curve of collected data, and finally comparing simulation results with the frequency wavenumber dispersion curve calculated by using the semi-analytical finite element method.

Preferably, in step 1, the variable cross-section turnout rail is longitudinally divided into (n−1) segments (5≤n≤72), and then dispersion curves of N sections of the variable cross-section rail are calculated separately.

Preferably, in step 3, in the simulation process, a lattice on a top wide end face of a straight switch rail is loaded with a vertical excitation signal, and the excitation signal is a 5-15 period sine wave signal with a center frequency of 25-40 kHz modulated by a Hanning window.

Preferably, in step 3, in a range of 0.32 m to 1.32 m from an excitation position, a group of data acquisition arrays is arranged every 3-6 mm, and then the frequency wavenumber dispersion curve of the collected data is identified by 2D-FFT.

Preferably, the semi-analytical finite element method is implemented as follows:

assuming that the rail is isotropic, the waves propagate in an x-direction and have equal cross-sections in a y-z plane; the displacement of any point in the rail can be expressed by a spatial distribution function as follows:

$$u ( x , y , z , t ) = [ \begin{matrix}{u}_{x} ( x , y , z , t ) \\ {u}_{y} ( x , y , z , t ) \\ {u}_{z} ( x , y , z , t )\end{matrix} ] = [ \begin{matrix}{U}_{x} ( y , z ) \\ {U}_{y} ( y , z ) \\ {U}_{z} ( y , z )\end{matrix} ] {e}^{i ( kx - ω t )} ;$$

where k is wavenumber, w is frequency, and an imaginary unit is i=\sqrt{−1};

an element mass matrix and a stiffness matrix are established by using the finite element method, and combined into a global matrix and a matrix eigenvalue problem of free harmonic vibration;

[K₁+ikK₂+k²K₃−w²M]U=0;

where Kn (n=1, 2, 3) is a matrix related to wavenumber, M is a mass matrix, and U denotes a feature vector; a propagation mode can be calculated by specifying an actual wavenumber in the equation and solving the eigenvalue problem, so as to obtain a real frequency and a mode shape;

or, to calculate a wavenumber at a specific frequency, an equation set can be arranged as:

$$[ A - kB ] \overline{U} = 0 ;$$

$$A = [ \begin{matrix}{K}_{1} - {ϖ}^{2} M & 0 \\ 0 & - {K}_{3}\end{matrix} ] , B = [ \begin{matrix}- i {K}_{2} & - {K}_{3} \\ - {K}_{3} & 0\end{matrix} ] , and \overline{U} = [ \begin{matrix}U \\ k U\end{matrix} ] ;$$

where 0 denotes a zero matrix with a size of M×M; the equations generate 2M eigenvalue outputs of M forward eigenvalue pairs and M reverse eigenvalue pairs; calculated eigenvalues each may be a real number, a complex number or an imaginary number; complex and imaginary eigenvalues denote evanescent modes, while real eigenvalues denote propagation modes at selected frequencies; and a formula for calculating group velocity is denoted as follows:

$${V}_{8} = \frac{\partial w}{\partial k} = \frac{{U}^{T} ( i {K}_{2} + 2 k {K}_{3} ) U}{2 w {U}^{T} M U} .$$

The technical effects of the present disclosure are as follows:

1. In the present disclosure, the turnout rail is divided into n characteristic sections and the semi-analytical finite element method is used to calculate the three-dimensional dispersion surface, saving calculation time.

2. Considering the characteristics of the continuous variable cross-section of the rail turnout, by selecting a special section of the turnout rail to study its dispersion curve, the dispersion surface and the dispersion characteristics of the entire turnout rail can be obtained.

3. Results of simulation verification prove the effectiveness of the method applied to variable cross-section rails, which provides effective theoretical guidance for detecting the propagation of elastic waves on variable cross-section rails.

### BRIEF DESCRIPTION OF THE DRAWINGS

FIG. 1 is a flowchart of the present disclosure;

FIG. 2 is a schematic diagram of a three-dimensional dispersion surface in an application example;

FIG. 3 is a schematic diagram of a wavenumber-frequency dispersion curve in an application example;

FIG. 4 is another schematic diagram of the wavenumber-frequency dispersion curve in the application example;

FIG. 5 is a schematic diagram of a mode 1 wave structure in an application example;

FIG. 6 is a schematic diagram of a mode 2 wave structure in an application example;

FIG. 7 is a schematic diagram of wave structures corresponding to different wavenumbers at 30 kHz in an application example;

FIG. 8 is a schematic diagram of a switch rail model in an application example;

FIG. 9 is a schematic diagram of an excitation signal in an application example;

FIG. 10 is a schematic diagram of node excitation simulation in an application example; and

FIG. 11 and FIG. 12 are schematic diagrams of frequency wavenumber dispersion curves in an application example.

### DESCRIPTION OF THE EMBODIMENTS

To further understand the contents of the present disclosure, the present disclosure will be described in detail in conjunction with the accompanying drawings and embodiments. It should be understood that the embodiments are merely used to explain the present disclosure and not to limit it.

### Embodiment 1

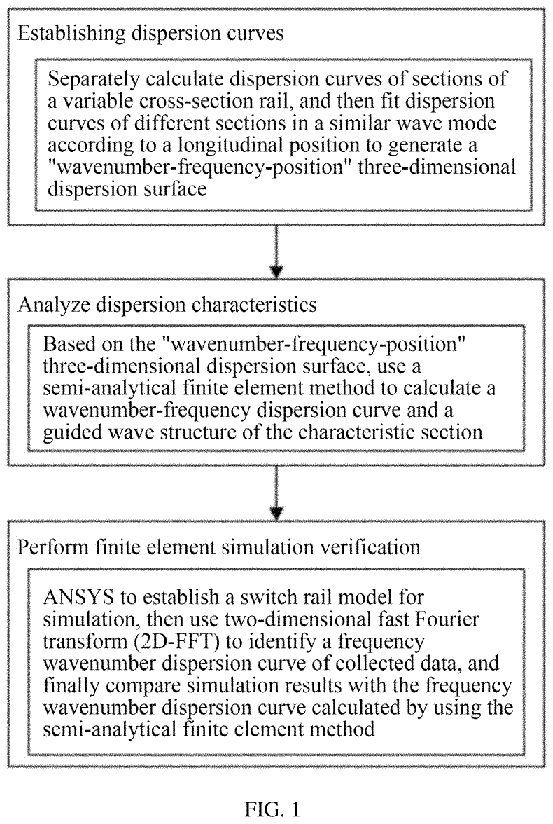

As shown in FIG. 1, this embodiment provides a method for determining propagation characteristics of guided waves of a variable cross-section rail of a turnout, including the following steps.

Step 1: Establish dispersion curves: separately calculate dispersion curves of sections of a variable cross-section rail, and then fit dispersion curves of different sections in a similar wave mode according to a longitudinal position to generate a “wavenumber-frequency-position” three-dimensional dispersion surface.

The dispersion characteristics of the waveguide structure have a direct relationship with the cross-sectional form. Considering that the actual cross-section of the variable cross-section rail of a high-speed turnout changes continuously and slowly in the longitudinal direction, which locally exhibits elastic wave propagation characteristics similar to those of a constant cross-section rail, the solution of a dispersion curve of each section at different positions shows that the dispersion curves between similar sections are basically the same. For the variable cross-section rail with a continuously changing cross-section, its dispersion characteristics change slowly along the longitudinal direction of the waveguide. Therefore, in step 1, first the variable cross-section turnout rail is divided into 14 segments in the longitudinal direction, and the distance between the cross-sections should be in such an arrangement that it is ensured that the longitudinal continuous change characteristics of the rail section can be reflected, and then dispersion curves of 15 sections of the variable cross-section rail are calculated separately.

Step 2: Analyze dispersion characteristics: based on the “wavenumber-frequency-position” three-dimensional dispersion surface, use a semi-analytical finite element method to calculate a wavenumber-frequency dispersion curve and a guided wave structure of the characteristic section.

The semi-analytical finite element method is implemented as follows:

In the semi-analytical finite element method, finite element discretization is performed on only the cross-section of a waveguide, and a propagation direction is analyzed. This method can be used to efficiently calculate the guided wave dispersion characteristics, but it needs to be assumed that the rail cross-sectional geometry and material characteristics along the propagation direction are constant. Assuming that the rail is isotropic, the waves propagate in an x-direction and have equal cross-sections in a y-z plane; the displacement of any point in the rail can be expressed by a spatial distribution function as follows:

$$u ( x , y , z , t ) = [ \begin{matrix}{u}_{x} ( x , y , z , t ) \\ {u}_{y} ( x , y , z , t ) \\ {u}_{z} ( x , y , z , t )\end{matrix} ] = [ \begin{matrix}{U}_{x} ( y , z ) \\ {U}_{y} ( y , z ) \\ {U}_{z} ( y , z )\end{matrix} ] {e}^{i ( kx - ω t )} ;$$

where k is wavenumber, w is frequency, and an imaginary unit is i=\sqrt{−1};

an element mass matrix and a stiffness matrix are established by using the finite element method, and combined into a global matrix and a matrix eigenvalue problem of free harmonic vibration;

[K₁+ikK₂+k²K₃−w²M]U=0;

where Kn (n=1, 2, 3) is a matrix related to wavenumber, M is a mass matrix, and U denotes a feature vector; a propagation mode can be calculated by specifying an actual wavenumber in the equation and solving the eigenvalue problem, so as to obtain a real frequency and a mode shape;

or, to calculate a wavenumber at a specific frequency, an equation set can be arranged as:

$$[ A - kB ] \overline{U} = 0 ;$$

$$A = [ \begin{matrix}{K}_{1} - {ϖ}^{2} M & 0 \\ 0 & - {K}_{3}\end{matrix} ] , B = [ \begin{matrix}- i {K}_{2} & - {K}_{3} \\ - {K}_{3} & 0\end{matrix} ] , and \overline{U} = [ \begin{matrix}U \\ k U\end{matrix} ] ;$$

where 0 denotes a zero matrix with a size of M×M; the equations generate 2M eigenvalue outputs of M forward eigenvalue pairs and M reverse eigenvalue pairs; calculated eigenvalues each may be a real number, a complex number or an imaginary number; complex and imaginary eigenvalues denote evanescent modes, while real eigenvalues denote propagation modes at selected frequencies; and a formula for calculating group velocity is denoted as follows:

$${V}_{8} = \frac{\partial w}{\partial k} = \frac{{U}^{T} ( i {K}_{2} + 2 k {K}_{3} ) U}{2 w {U}^{T} M U} .$$

Perform finite element simulation verification: use ANSYS to establish a switch rail model for simulation, then use 2D-FFT to identify a frequency wavenumber dispersion curve of collected data, and finally compare simulation results with the frequency wavenumber dispersion curve calculated by using the semi-analytical finite element method.

Preferably, in the simulation process, a lattice on a top wide end face of a straight switch rail is loaded with a vertical excitation signal, and the excitation signal is a 10 period sine wave signal with a center frequency of 30 kHz modulated by a Hanning window.

In a range of 0.32 m to 1.32 m from an excitation position, a group of data acquisition arrays is arranged every 4 mm, and then the frequency wavenumber dispersion curve of the collected data is identified by 2D-FFT.

### Embodiment 2

This embodiment differs from Embodiment 1 in that:

In step 1, the variable cross-section turnout rail is longitudinally divided into 4 segments, the distance between the cross-sections should be in such an arrangement that it is ensured that the longitudinal continuous change characteristics of the rail section can be reflected, and then dispersion curves of 5 sections of the variable cross-section rail are calculated separately.

In step 3, in the simulation process, a lattice on a top wide end face of a straight switch rail is loaded with a vertical excitation signal, and the excitation signal is a 5 period sine wave signal with a center frequency of 25 kHz modulated by a Hanning window. In a range of 0.32 m to 1.32 m from an excitation position, a group of data acquisition arrays is arranged every 3 mm, and then the frequency wavenumber dispersion curve of the collected data is identified by 2D-FFT.

### Embodiment 3

This embodiment differs from Embodiment 1 in that:

In step 1, the variable cross-section turnout rail is longitudinally divided into 22 segments, the distance between the cross-sections should be in such an arrangement that it is ensured that the longitudinal continuous change characteristics of the rail section can be reflected, and then dispersion curves of 23 sections of the variable cross-section rail are calculated separately.

In step 3, in the simulation process, a lattice on a top wide end face of a straight switch rail is loaded with a vertical excitation signal, and the excitation signal is a 12 period sine wave signal with a center frequency of 30 kHz modulated by a Hanning window. In a range of 0.32 m to 1.32 m from an excitation position, a group of data acquisition arrays is arranged every 5 mm, and then the frequency wavenumber dispersion curve of the collected data is identified by 2D-FFT.

### Embodiment 4

This embodiment differs from Embodiment 1 in that:

In step 1, the variable cross-section turnout rail is longitudinally divided into 71 segments, the distance between the cross-sections should be in such an arrangement that it is ensured that the longitudinal continuous change characteristics of the rail section can be reflected, and then dispersion curves of 72 sections of the variable cross-section rail are calculated separately.

In step 3, in the simulation process, a lattice on a top wide end face of a straight switch rail is loaded with a vertical excitation signal, and the excitation signal is a 15 period sine wave signal with a center frequency of 40 kHz modulated by a Hanning window. In a range of 0.32 m to 1.32 m from an excitation position, a group of data acquisition arrays is arranged every 6 mm, and then the frequency wavenumber dispersion curve of the collected data is identified by 2D-FFT.

### Application Example

A dispersion surface can reflect dispersion curves of sections at different positions and the law of longitudinal variation of the dispersion characteristics of a similar wave mode, and combined with the wave structure corresponding to a “wavenumber-frequency-position” point on the dispersion surface, the propagation law of elastic waves in the variable cross-section rail is studied.

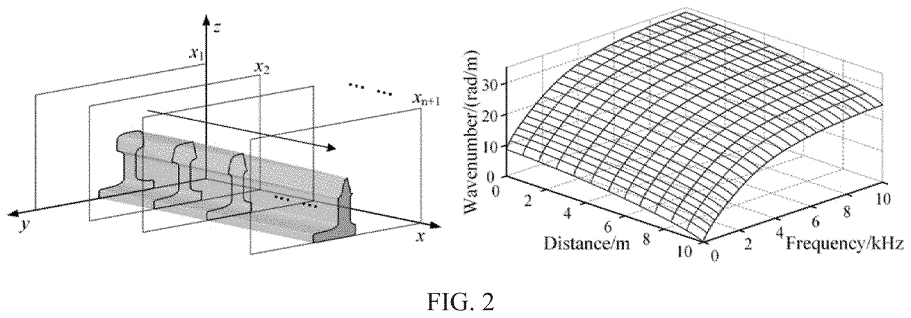

The method described in Embodiment 1 for determine guided wave propagation characteristics of a variable cross-section turnout rail of a straight switch rail of a No. 18 high-speed turnout is taken as an example. The variable cross-section segment has a total length of 11792 mm, and the top width is in transition from 0 mm to 72.2 mm A top width of 5 mm is taken as the step length to intercept the characteristic section, and the dispersion curve of each characteristic section is solved based on the semi-analytical finite element method. As shown in FIG. 2, dispersion curves of sections of a variable cross-section rail are separately calculated, and then dispersion curves of different sections in a similar wave mode are fitted according to a longitudinal position to generate a “wavenumber-frequency-position” three-dimensional dispersion surface.

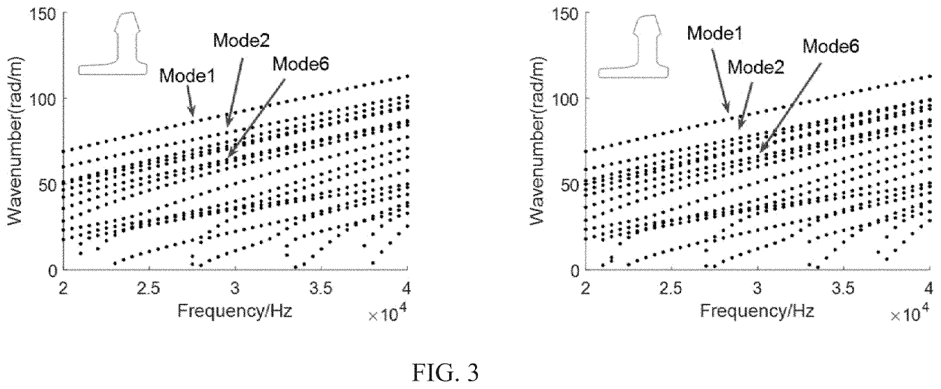

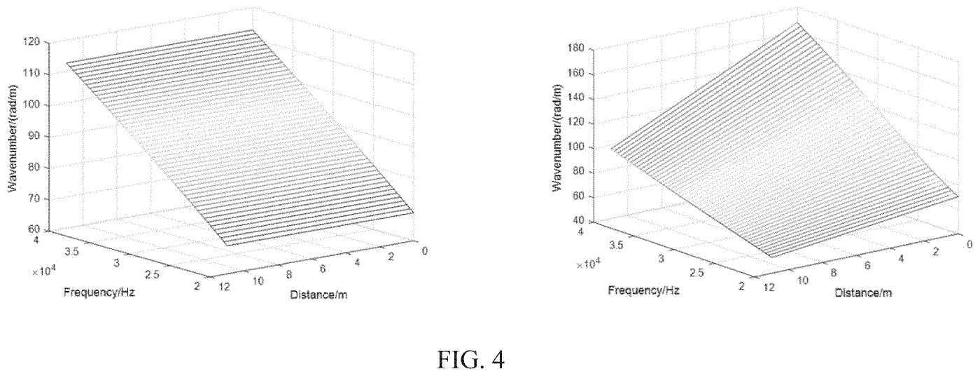

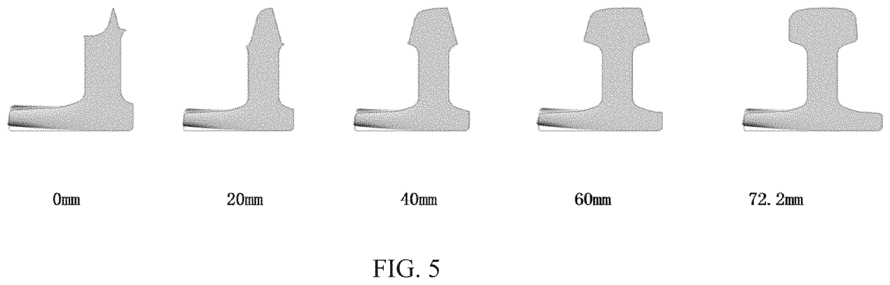

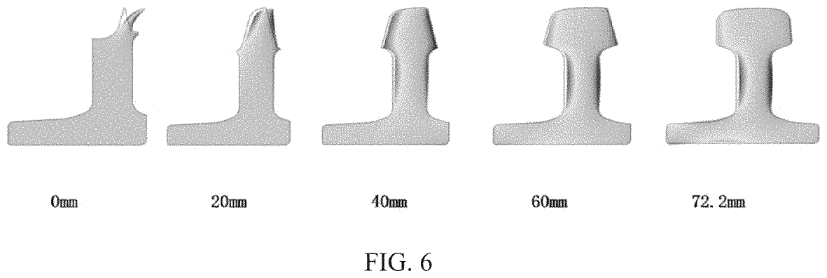

Here, the dispersion curves of two key control sections in the milling process of the turnout switch rail are selected for comparative analysis. The top widths are 30 mm and 35 mm respectively. The section forms and their dispersion curves are shown in FIG. 3. Guided wave modes corresponding to the sections of different switch rails and guided wave structures thereof at 30 kHz are shown in FIG. 4, FIG. 5 and FIG. 6.

It can be seen from FIG. 3 that the wavenumber-frequency dispersion curves corresponding to similar sections are similar. A guided wave mode 1 and a guided wave mode 2 are selected to illustrate the dispersion characteristics of the variable cross-section straight switch rail. It can be seen from FIG. 4(a) and FIG. 5 that the guided wave structures of the guided wave mode 1 corresponding to rail bottoms are similar, and the shapes and material parameters at deformation positions of different switch rail sections are the same, so that the dispersion curve corresponding to the guided wave mode 1 does not change. It can be seen from FIG. 4(b) and FIG. 6 that the dispersion curve corresponding to guided wave mode 2 changes slowly with the change of the switch rail section, and the guided wave structure also changes slowly.

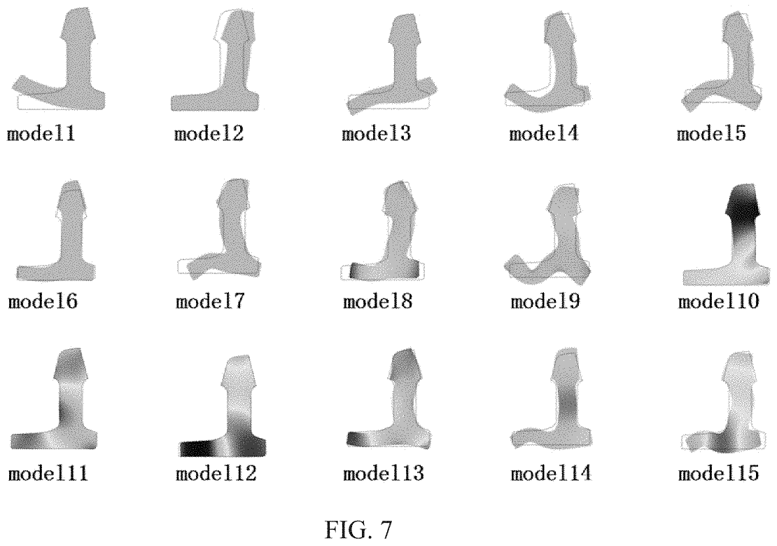

The semi-analytical finite element method is used to calculate a wavenumber-frequency dispersion curve and a guided wave structure of the section of the switch rail with a top width of 35 mm FIG. 7 shows the guided wave structure of the section of the switch rail with a top width of 35 mm at 30 kHz. The structure is represented by a RAINBOW legend. The color ratios corresponding to different guided wave modes are consistent. Mode 1 to mode 9 are mainly realized as in-plane deformation, and mode 10 to mode 15 are mainly realized as out-of-plane deformation.

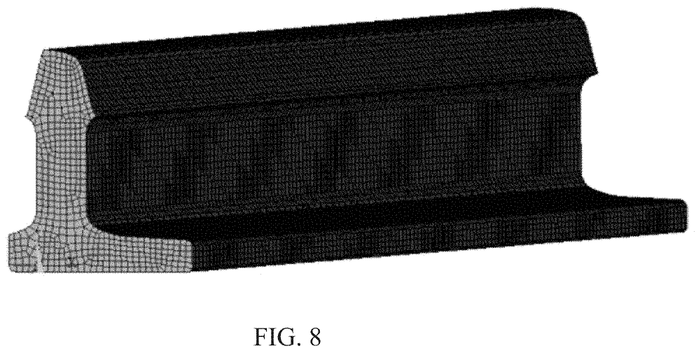

In step 3, ANSYS is used to establish a switch rail model (the switch rail top width is 30-40 mm), as shown in FIG. 8. In this application example, an 8-node solid lattice is used to perform meshing on a 3D solid element model of the turnout, and the mesh size is 1/10 of the wavelength of the guided wave.

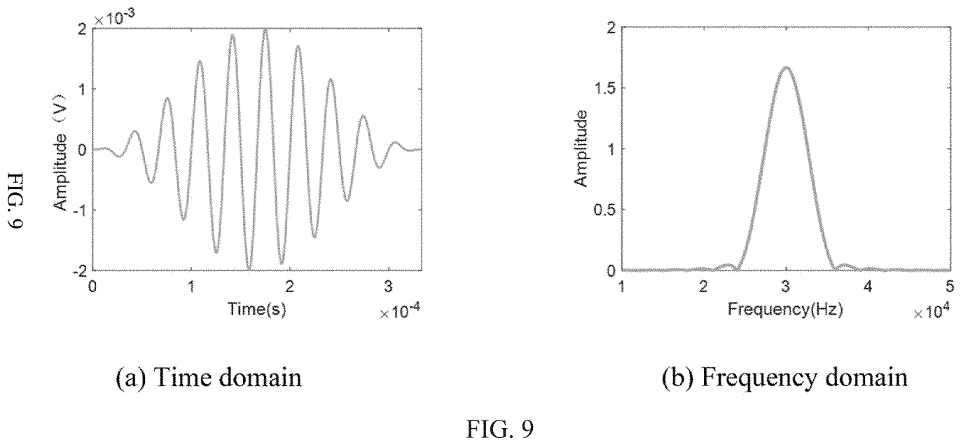

In step 3, in the simulation process, a lattice on a top wide end face of a straight switch rail is loaded with a vertical excitation signal, and the excitation signal is a 10 period sine wave signal with a center frequency of 30 kHz modulated by a Hanning window, specifically as shown in FIG. 9.

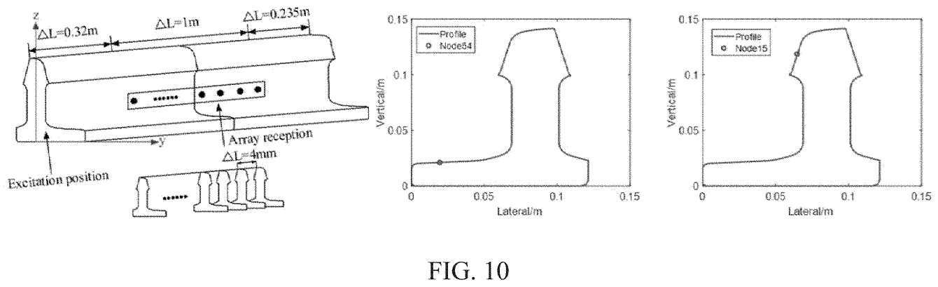

In step 3, in a range of 0.32 m to 1.32 m from an excitation position, a group of data acquisition arrays is arranged every 4 mm, and there are 251 data acquisition nodes, specifically as shown in FIG. 10, and then the frequency wavenumber dispersion curve of the collected data is identified by 2D-FFT.

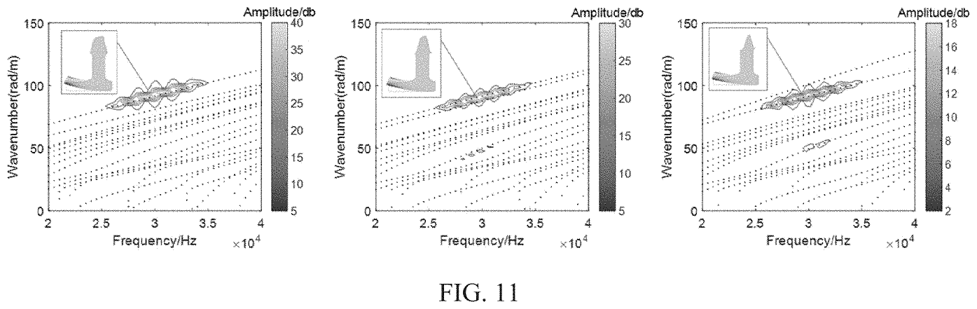

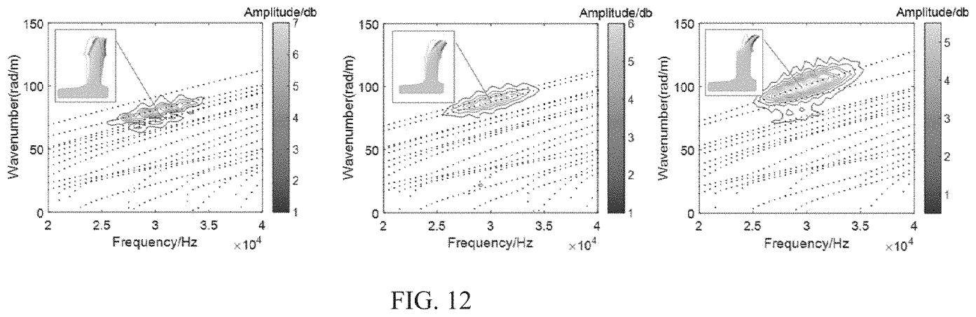

Simulation results are compared with the frequency wavenumber dispersion curves calculated by using the semi-analytical finite element method, as shown in FIG. 11 and FIG. 12. Results of 2D-FFT are in good agreement with the frequency-wavenumber curve of the corresponding mode. The result in FIG. 11 corresponds to mode 6 in FIG. 6, and the result in FIG. 12 corresponds to mode 1 in FIG. 6. It is proved that this theoretical analysis method has been well theoretically verified for the study of the dispersion characteristics of continuously variable cross-section rails.

The present disclosure and implementations thereof have been schematically described above, and the description is not restrictive. The accompanying drawings also show only one of the implementations of the present disclosure, and the actual structure is not limited thereto. Therefore, if a person of ordinary skill in the art designs structural modes and embodiments similar to this technical solution without creativity under the enlightenment without departing from the creation purpose of the present disclosure, the structural modes and the embodiments should fall within the protection scope of the present disclosure.

What is claimed is:

1. A method for determining propagation characteristics of guided waves of a variable cross-section rail of a turnout, comprising the following steps:
step 1: establishing dispersion curves: separately calculating dispersion curves of sections of a variable cross-section rail, and then fitting dispersion curves of different sections in a similar wave mode according to a longitudinal position to generate a “wavenumber-frequency-position” three-dimensional dispersion surface;
step 2: analyzing dispersion characteristics: based on the “wavenumber-frequency-position” three-dimensional dispersion surface, using a semi-analytical finite element method to calculate a wavenumber-frequency dispersion curve and a guided wave structure of the characteristic section; and
step 3: performing finite element simulation verification: using ANSYS to establish a switch rail model for simulation, then using two-dimensional fast Fourier transform (2D-FFT) to identify a frequency wavenumber dispersion curve of collected data, and finally comparing simulation results with the frequency wavenumber dispersion curve calculated by using the semi-analytical finite element method.

2. The method for determining propagation characteristics of guided waves of a variable cross-section rail of a turnout according to claim 1, wherein in step 1, the variable cross-section turnout rail is longitudinally divided into (n−1) segments, wherein 5≤n≤72, and then dispersion curves of N sections of the variable cross-section rail are calculated separately.

3. The method for determining propagation characteristics of guided waves of a variable cross-section rail of a turnout according to claim 1, wherein in step 3, in the simulation process, a lattice on a top wide end face of a straight switch rail is loaded with a vertical excitation signal, and the excitation signal is a 5-15 period sine wave signal with a center frequency of 25-40 kHz modulated by a Hanning window.

4. The method for determining propagation characteristics of guided waves of a variable cross-section rail of a turnout according to claim 3, wherein in step 3, in a range of 0.32 m to 1.32 m from an excitation position, a group of data acquisition arrays is arranged every 3-6 mm, and then the frequency wavenumber dispersion curve of the collected data is identified by 2D-FFT.

5. The method for determining propagation characteristics of guided waves of a variable cross-section rail of a turnout according to claim 1, wherein the semi-analytical finite element method is implemented as follows:
assuming that the rail is isotropic, the waves propagate in an x-direction and have equal cross-sections in a y-z plane; the displacement of any point in the rail can be expressed by a spatial distribution function as follows:
$$u ( x , y , z , t ) = [ \begin{matrix}{u}_{x} ( x , y , z , t ) \\ {u}_{y} ( x , y , z , t ) \\ {u}_{z} ( x , y , z , t )\end{matrix} ] = [ \begin{matrix}{U}_{x} ( y , z ) \\ {U}_{y} ( y , z ) \\ {U}_{z} ( y , z )\end{matrix} ] {e}^{i ( kx - ω t )} ;$$
wherein k is wavenumber, w is frequency, and an imaginary unit is i=\sqrt{−1};
an element mass matrix and a stiffness matrix are established by using the finite element method, and combined into a global matrix and a matrix eigenvalue problem of free harmonic vibration;
[K₁+ikK₂+k²K₃−w²M]U=0;
wherein Kn (n=1, 2, 3) is a matrix related to wavenumber, M is a mass matrix, and U denotes a feature vector; a propagation mode can be calculated by specifying an actual wavenumber in the equation and solving the eigenvalue problem, so as to obtain a real frequency and a mode shape;
or, to calculate a wavenumber at a specific frequency, an equation set can be arranged as:
$$[ A - kB ] \overline{U} = 0 ;$$
$$A = [ \begin{matrix}{K}_{1} - {ϖ}^{2} M & 0 \\ 0 & - {K}_{3}\end{matrix} ] , B = [ \begin{matrix}- i {K}_{2} & - {K}_{3} \\ - {K}_{3} & 0\end{matrix} ] , and \overline{U} = [ \begin{matrix}U \\ k U\end{matrix} ] ;$$
wherein 0 denotes a zero matrix with a size of M×M; the equations generate 2M eigenvalue outputs of M forward eigenvalue pairs and M reverse eigenvalue pairs; calculated eigenvalues each may be a real number, a complex number or an imaginary number; complex and imaginary eigenvalues denote evanescent modes, while real eigenvalues denote propagation modes at selected frequencies; and a formula for calculating group velocity is denoted as follows:
$${V}_{8} = \frac{\partial w}{\partial k} = \frac{{U}^{T} ( i {K}_{2} + 2 k {K}_{3} ) U}{2 w {U}^{T} M U} .$$
